(19) United States
(12) Patent Application Publication
(10) Pub. No.: US 2026/0209982 A1
(43) Pub. Date: Jul. 23, 2026

(54) METHOD FOR WET-DEPOSITING A METAL MATRIX COMPOSITE PLATING ON A SUPPORT PART

(71) Applicant: The Swatch Group Research and Development Ltd, Marin-Epagnier (CH)

(72) Inventors: Christophe VINCENT, Montperreux (FR); Thomas CORDONNIER, Villers-Le-Lac (FR)

(73) Assignee: The Swatch Group Research and Development Ltd, Marin-Epagnier (CH)

(21) Appl. No.: 19/400,289

(22) Filed: Nov. 25, 2025

(30) Foreign Application Priority Data
Dec. 19, 2024 (EP) 24221877.4

(51) Int. Cl. C25D 3/12; B32B 15/01; G04D 3/00

(52) U.S. Cl. CPC C25D 3/12; B32B 15/01; G04D 3/0069; G04D 3/0074; B32B 2311/22

(57) ABSTRACT

A method for depositing a metal matrix composite plating on a support part, including the following steps: immersing the support part to be plated in an electrolytic bath containing the metal to be deposited (50), then depositing the metal in layers on the support part to be plated by electrodeposition (60), wherein, prior to immersing the support part to be plated in the electrolytic bath, a two-dimensional material is incorporated and dispersed in the electrolytic bath (30) in a given amount so as to distribute the two-dimensional material homogeneously throughout the thickness of the metal matrix formed by the layered metal.

### CROSS-REFERENCE TO RELATED APPLICATIONS

This application claims priority to European Patent Application No. 24221877.4 filed Dec. 19, 2024, the entire contents of which are incorporated herein by reference.

### TECHNICAL FIELD OF THE INVENTION

The invention relates to the wet deposition of a plating on a support part or substrate such as a horology component.

The invention relates more specifically to a method for depositing a metal matrix composite plating on a support part, comprising the following steps: immersing the support part to be plated in an electrolytic bath containing the metal to be deposited, then depositing the metal in a layer on the support part to be plated by electrodeposition.

The method is intended in particular, but not exclusively, for use in plating horology parts. The horology parts in question include, but are not limited to, parts intended to be in frictional contact with another horology part, such as an escapement wheel, an axis, a gear, etc.

### TECHNOLOGICAL BACKGROUND

In horology mechanisms, many moving parts come into contact with each other, generating friction. Such friction causes wear on the parts, increases the energy consumption required to move the parts and slows down the movement, affecting both the precision and the autonomy of the mechanism. It is therefore essential to reduce friction as much as possible to ensure that the horology movement functions properly.

To reduce this friction, it is common practice to lubricate horology mechanisms with liquid lubricants (oils) or paste lubricants (grease) used on specific zones and in suitable quantities. The drawback of such lubricants is that they can leak out of the zones to which they have been applied. Moreover, their behaviour can be heavily influenced by environmental conditions, such as temperature and humidity, which can affect their viscosity. Furthermore, this lubrication method is not permanent: it has to be renewed, as the lubricant may have dried out or become contaminated by wear-related debris, making relubrication essential after a few years.

To remedy the drawback of liquid or paste lubricants, dry lubrication solutions have been developed, in particular through the deposition of dry lubrication plating. Such dry lubrication plating has the advantage of being attached to the parts to be protected, thereby limiting the risk of loss while offering greater resistance to chemical degradation and reduced sensitivity to environmental conditions. Dry lubrication plating includes plating based on carbon nanotubes dispersed in a nickel matrix, as well as nickel-based plating and Polytetrafluoroethylene (PFTE) plating. Such plating is described, for example, in patent applications US20080123475 and EP4390556.

Although dry lubrication solutions offer improvements over liquid or paste lubricants, there is still room for improvement in terms of friction issues and enhanced tribological properties. In particular, improvements in dry friction reduction and wear resistance are always sought.

The invention aims to provide a method for depositing a plating on a support part and that improves the tribological properties of the plated support part, in particular by offering a lower coefficient of friction and improved wear resistance.

The invention also aims to provide a horology part intended to be in frictional contact with another horology part, with improved tribological properties and in particular offering a lower coefficient of friction and improved wear resistance.

### SUMMARY OF THE INVENTION

The invention relates to a method for depositing a metal matrix composite plating on a support part, comprising the following steps: immersing the support part to be plated in an electrolytic bath containing the metal to be deposited, then depositing the metal in layers on the support part to be plated by electrodeposition, the method being remarkable in that, prior to immersing the support part to be plated in the electrolytic bath, a two-dimensional material is incorporated and dispersed in the electrolytic bath in a given amount so as to distribute the two-dimensional material homogeneously throughout the thickness of the metal matrix formed by the layered metal.

Preferably, the two-dimensional material is chosen from the MXenes family, with the general formula Mₙ₊₁XₙTₓ, wherein:
n=1 to 3 and
“M” is a transition metal chosen from the group comprising titanium, vanadium, chromium, yttrium, zirconium, niobium, molybdenum, hafnium, tantalum or tungsten,
“X” is carbon or nitrogen, and
“T” is a surface termination comprising oxygen, hydrogen, chlorine, fluorine, or a combination of these compounds. “X” being an integer variable dependent on the surface termination “T.”

Depending on the chosen foil exfoliation method, the surface termination Tₓ can be omitted. In this case, the two-dimensional material is chosen from the MXenes family, with the general formula Mₙ₊₁Xₙ. Adding MXenes has the advantage of improving the tribological properties of the support part due to the effects of its own structure (the layers slide against each other, which limits friction), but also the termination of the MXene. Tribochemical reactions can also occur with the lubricant and the friction materials to limit wear.

Advantageously, the MXenes are incorporated into the electrolytic bath in the form of individual or agglomerated sheets.

Advantageously it can be provided that, prior to incorporating the two-dimensional material into the electrolytic bath, at least one surface-active agent is incorporated into the electrolytic bath.

Advantageously, the electrolytic bath to which the two-dimensional material has been added undergoes an ultrasonication operation.

Advantageously, the support part on which the plating is deposited is a horology part.

Another aspect of the invention relates to a horology part designed to come into frictional contact with a contact surface in another horology part, characterised in that it comprises a plating formed from a composite comprising a metal matrix to which a two-dimensional material has been added.

Advantageously, the two-dimensional material is chosen from the MXenes family, with the general formula Mₙ₊₁XₙTₓ, wherein:
n=1 to 3,
“M” is a transition metal chosen from the group comprising titanium, vanadium, chromium, yttrium, zirconium, niobium, molybdenum, hafnium, tantalum or tungsten,
“X” is carbon or nitrogen, and
“T” is a surface termination comprising oxygen, hydrogen, chlorine, fluorine, or a combination of these compounds. “X” being an integer variable dependent on the surface termination “T.”
   Depending on the chosen foil exfoliation method, the surface termination Tₓ can be omitted. In this case, the two-dimensional material is chosen from the MXenes family, with the general formula Mₙ₊₁Xₙ.

Advantageously, the chosen MXenes is Ti₃C₂.

Advantageously, the metal matrix is a nickel-based matrix.

### BRIEF DESCRIPTION OF THE FIGURES

Other features and advantages of the invention will be apparent from the following detailed description of the invention, provided by way of example and made with reference to the attached figures, in which:

FIG. 1 shows the steps involved in depositing a metal matrix composite plating according to an exemplary embodiment of the deposition method according to the invention,

FIG. 2 is a graph showing the average dynamic coefficient of friction of different samples tested under specific conditions (long amplitude),

FIG. 3 is a graph showing the average dynamic coefficient of friction of different samples tested under specific conditions (short amplitude),

### DETAILED DESCRIPTION OF THE INVENTION

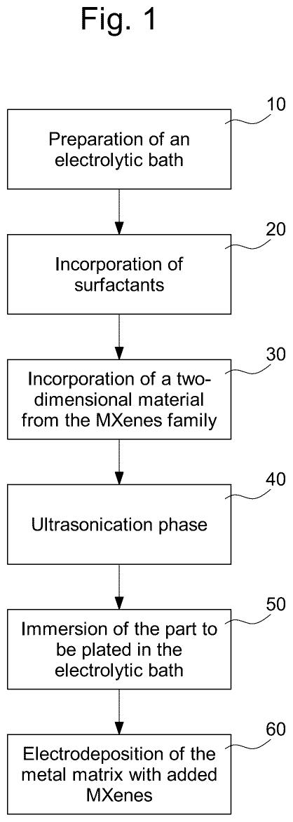

FIG. 1 illustrates a schematic representation of the steps involved in depositing a metal matrix composite plating on a support part according to an exemplary embodiment of the method according to the invention.

In the example that will be described, the composite plating the support part is formed from nickel (matrix) and from a two-dimensional (2D) material chosen from the MXenes family with the general formula Mₙ₊₁XₙTₓ, wherein:
n=1 to 3,
“M” is a transition metal chosen from the group comprising titanium, vanadium, chromium, yttrium, zirconium, niobium, molybdenum, hafnium, tantalum or tungsten,
“X” is carbon or nitrogen, and
“T” is a surface termination comprising oxygen, hydrogen, chlorine, fluorine, or a combination of these compounds. “X” being an integer variable dependent on the surface termination “T.”
   Depending on the chosen foil exfoliation method, the surface termination Tₓ can be omitted. In this case, the two-dimensional material is chosen from the MXenes family, with the general formula Mₙ₊₁Xₙ.

The MXenes contained in the composite are thus composed of “n+1,” wherein n=1 to 3, layers of a transition metal referenced “M,” which can be one of the aforementioned metals, said metal layers being separated by “n” layers of carbon or nitrogen, wherein “T” represents functional groups enabling the surface properties of the MXene to be adjusted.

To deposit the metal matrix composite plating, the first step is to prepare an electrolytic bath, preferably galvanic, to reduce the metal (in this case nickel) on the support part (step 10). The electrolytic bath consists of a solution into which the MXenes will be incorporated, the solution containing the metal to be deposited, electrolytes for conducting the electric current in the bath and a solvent (water).

Before incorporating the MXenes, it is advantageous to add at least one surface-active agent to the electrolytic bath (step 20). The surfactants are used to charge the surface of the MXene sheets. These surface charges act, on one hand, to keep the MXenes sheets from agglomerating again once they have been separated according to the principles of electrostatic and steric repulsion, thus ensuring the stability of the suspension, and, on the other hand, to enable these sheets to be incorporated homogeneously and sufficiently by electrophoresis into the matrix.

Once the surfactants have been added, the MXenes are incorporated in single (individual) sheets or agglomerated in the electrolytic bath in a sufficient amount to ensure homogeneous distribution of the sheets throughout the thickness of the deposit (step 30).

To incorporate non-agglomerated single sheets or agglomerated sheets, an ultrasonication phase in the solution (step 40) is necessary or at least preferable. The sound waves will in fact enable complete mechanical separation of the sheets grouped in single sheets, although the single sheets may agglomerate slightly when they are placed in the solution. Preferably, non-agglomerated sheets are to be incorporated. Once the sheets have separated, the surfactants will bind to their surface, conferring the advantages of stability and electrophoretic mobility described above.

Once the MXenes have stabilised, the support part to be plated is immersed in the electrolytic bath to which MXenes has been added (step 50).

The metal matrix composite is then deposited (step 60). Such a deposition can be carried out under the same conditions as a deposition in a “conventional” electrolytic bath, in other words, one with no additives, but also in a bath to which grain refiners or levelling agents have been added, and irrespective of the electrodeposition method used (direct or pulsating current, etc.).

Comparative tribological tests were carried out on samples of steel plated with a nickel/MXenes composite prepared using the method described above and on a sample of steel plated with nickel similar to the plating that might be found on a horology part such as an escapement wheel—in other words, with no added MXenes. The test conditions correspond to the horological contact of the Swiss pallet escapement in terms of stress and velocity and with no added contact lubricant.

The tests were carried out with a ball-on-disc tribometer, the ball being made with a typical counteracting horology part (in the example, ruby) and the disc being plated with the composite deposit to be tested or with a nickel deposit similar to that found on a horology part such as an escapement wheel. The tests were split between long and short amplitudes to bias either the deposit or the counteracting part in a preferential way. The MXene used in these tests is Ti₃C₂.

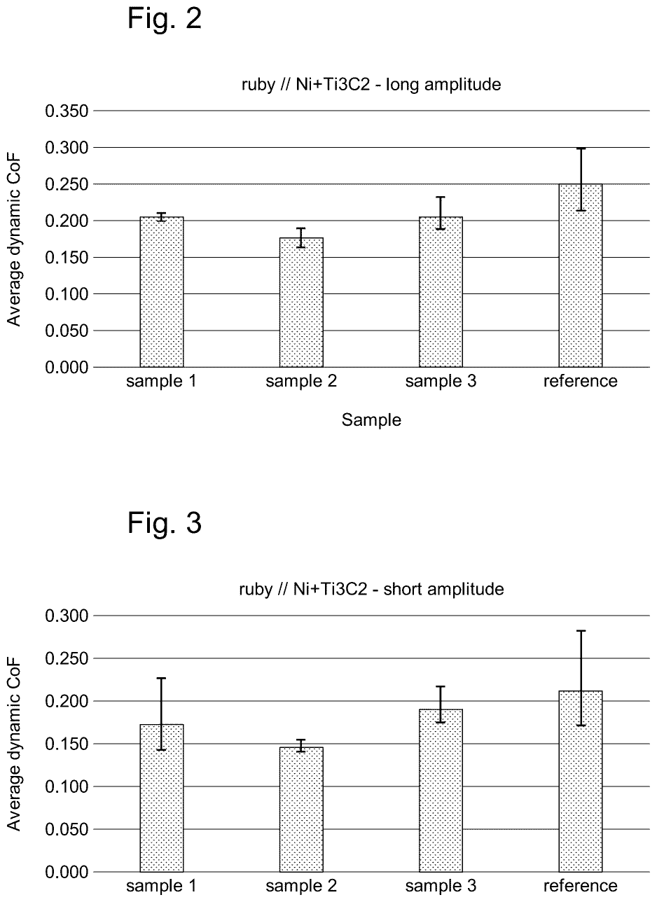

The results are shown in FIG. 2 (long amplitude) and FIG. 3 (short amplitude).

Three samples plated with a metal matrix composite deposit, nickel and Ti₃C₂, and identified as “sample 1”, “sample 2” and “sample 3”, were thus prepared using the method described above and tribologically tested on a tribometer. The 3 samples correspond to increasing deposition times and therefore to increasing thickness. “Sample 1” corresponds to a thickness of 1 μm, “sample 2” to 5 μm and “sample 3” to 10 μm. As previously mentioned, contact is made between a ruby bead and a disc plated with a composite nickel/Ti₃C₂ deposit. A comparison was made with a fourth sample of nickel-plated steel with no added MXenes, as might be found on a horology part such as an escapement wheel. The fourth sample is identified as “reference.”

Vertical lines on each bar indicate variability in the measures.

Whether long or short amplitudes were applied, the “reference” sample had a higher average dynamic coefficient of friction (CoF) value (of approximately 0.25 for long amplitude and approximately 0.21 for short amplitude), with greater variability than in “sample 1” to “sample 3.”

The samples containing the nickel/Ti₃C₂ deposit therefore had lower average dynamic coefficients of friction than the reference, indicating better performance of these materials in reducing friction. “Sample 2” had the best performance, with the lowest average CoF and limited variability.

The results therefore show a gain in the coefficient of friction of the three samples according to the invention (“sample 1” to “sample 3”) compared to the “reference” sample. Moreover, in terms of wear, over a relatively low number of cycles (3,000 cycles), no debris appeared on the ruby or the plating.

Tribological testing has shown that the addition of MXenes, in this case Ti₃C₂ in a metal matrix, and particularly in a nickel matrix, improves dry contact performance in horology parts with a reduction in the average dynamic coefficient of friction compared with a MXenes-free nickel plating, and does so without altering contact wear.

The above description of the invention is provided by way of example. It is understood that the person skilled in the art is capable of arriving at different variants of the invention without departing from the scope of the invention.

### TERMINOLOGY

10: Preparation of an electrolytic bath
20: Incorporation of surfactants
30: Incorporation of a two-dimensional material from the MXenes family
40: Ultrasonication phase
50: Immersion of the support part to be plated in the electrolytic bath
60: Electrodeposition of the metal matrix with added MXenes

1. A method for depositing a metal matrix composite plating on a support part, comprising the following steps: immersing the support part to be plated in an electrolytic bath containing the metal to be deposited (50), then depositing the metal in layers on the support part to be plated by electrodeposition (60), wherein, prior to immersing the support part to be plated in the electrolytic bath, a two-dimensional material is incorporated and dispersed in the electrolytic bath (30) in a given amount so as to distribute the two-dimensional material homogeneously throughout the thickness of the metal matrix formed by the layered metal.

2. The method for depositing a metal composite plating according to claim 1, wherein the two-dimensional material is chosen from the MXenes family, with the general formula Mₙ₊₁XₙTₓ, wherein:
n=1 to 3 and
“M” is a transition metal chosen from the group comprising titanium, vanadium, chromium, yttrium, zirconium, niobium, molybdenum, hafnium, tantalum or tungsten,
“X” is carbon or nitrogen, and
“T” is a surface termination comprising oxygen, hydrogen, chlorine, fluorine, or a combination of these compounds.

3. The method for depositing a metal composite plating according to claim 2, wherein the MXenes are incorporated into the electrolytic bath in the form of individual or agglomerated sheets.

4. The method for depositing a metal composite plating according to claim 1, wherein, prior to incorporating the two-dimensional material into the electrolytic bath, at least one surface-active agent is incorporated into the electrolytic bath (20).

5. The method for depositing a metal composite plating according to claim 1, wherein the electrolytic bath to which the two-dimensional material has been added undergoes an ultrasonication operation (40).

6. The method for depositing a metal composite plating according to claim 1, wherein the support part on which the plating is deposited is a horology part.

7. A horology part designed to come into frictional contact with a contact surface in another horology part, further comprising a plating formed from a composite comprising a metal matrix to which a two-dimensional material has been added.

8. The horology part according to claim 7, wherein the two-dimensional material is chosen from the MXenes family with the general formula Mₙ₊₁XₙTₓ, wherein:
n=1 to 3,
“M” is a transition metal chosen from the group comprising titanium, vanadium, chromium, yttrium, zirconium, niobium, molybdenum, hafnium, tantalum or tungsten,
“X” is carbon or nitrogen, and
“T” is a surface termination comprising oxygen, hydrogen, chlorine, fluorine, or a combination of these compounds.

9. The horology part according to claim 7, wherein the chosen MXene is Ti₃C₂.

10. The horology part according to claim 7, wherein the metal matrix is a nickel base matrix.
